(19) United States
(12) Patent Application Publication
(10) Pub. No.: US 2003/0116398 A1
(43) Pub. Date: Jun. 26, 2003

(54) Facing having two-layered structure and manufacturing method for the same

(75) Inventor: Kunihiro Nomura, Osaka (JP)

Correspondence Address: SHINJYU GLOBAL IP COUNSELORS, LLP, 1233 20TH STREET, NW, SUITE 700, WASHINGTON, DC, 20036-2680, US

(73) Assignee: EXEDY CORPORATION

(21) Appl. No.: 10/310,828

(22) Filed: Dec. 6, 2002

(30) Foreign Application Priority Data
Dec. 20, 2001 (JP) 2001-387755
Sep. 10, 2002 (JP) 2002-264251

(51) Int. Cl. F16D 69/00

(52) U.S. Cl. 192/107 M

(57) ABSTRACT

A backing molding material preparation step 21 for a two-layered facing 1 has a papermaking step 22 in which a paper is made that is coated with a binding agent and dried to obtain a paper sheet 4; a cutting step 23 in which the paper sheet 4 is cut into a tape-like form; a bending step 24 in which a lengthwise crease is made in the tape-like paper sheet 4; a winding step 25 in which the creased paper sheet 4 wound into a ring shape to obtain backing molding material 5. Afterwards, in the molding step 31, the two-layered facing 1 having multiple air cavities 6 is manufactured by laminating together the front material 2 manufactured in front material preparation step 11 and the creased backing molding material 5 manufactured in the backing material preparation step 21 and thermally molding the two materials integrally together while applying pressure.

### BACKGROUND OF THE INVENTION

1. Field of the Invention

This invention generally relates to a facing. More specifically, the present invention relates to a facing having a two-layered structure and a manufacturing method for the same.

2. Background Information

Automotive clutches use a clutch disc that intermittently engages with a flywheel and transfers power by means of friction. A conventional clutch disc has, for example, two annular friction facings and a cushioning plate disposed therebetween. Known structures for the annular friction facings include a two-layered structure in which a front material and a backing material are integrally molded together. The front material serves as a friction surface. The backing material serves to support and reinforce the front material. In a two-layered friction facing, the friction performance is accomplished by the front material and the rotational strength is accomplished by the backing material. Consequently, both excellent friction performance and high rotational strength can be achieved simultaneously.

Conventionally, the backing material used in this kind of friction facing is made of a material such as a light alloy or glass mat that has been punched into a ring shape. When the backing material is manufactured by punching, the yield of the light alloy or glass mat material is poor. Furthermore, heat resistance and lighter weight are also performance factors demanded of the backing material.

In view of the above, there exists a need for a facing having a two-layered structure and a manufacturing method for the same that overcomes the above-mentioned problems in the prior art. The present invention addresses this need in the prior art as well as other needs, which will become apparent to those skilled in the art from this disclosure.

### SUMMARY OF THE INVENTION

An object of the present invention is to provide a backing material of a facing having a two-layered structure and a high porosity so as to improve the heat radiation performance of a front material, which serves as a friction material, and thereby improve the friction performance and heat resistance of the facing. Another object of the present invention is to provide a manufacturing method of the two-layered facing that improves the yield of the material used to make the backing material.

A two-layered facing in accordance with a first aspect of the present invention has a front material and a backing molding material. The front material has a friction surface and is molded integrally with the backing molding material. The backing molding material is obtained by winding a paper sheet containing short fibers, pulp material, and a binding agent into a ring shape. A backing material is fabricated by molding the backing molding material integrally with the front material. The backing material has a porosity of 8% or more by volume.

With this two-layered facing, since the porosity of the backing material is relatively high, i.e., 8% or more by volume, the front material has excellent heat radiation performance. Further, the fade resistance and stall resistance are improved. The porosity mentioned here refers to the percentage of air cavities in the facing and is the value obtained by dividing the apparent density of the facing by the true density.

A two-layered facing in accordance with a second aspect of the present invention is the facing of the first aspect having an apparent density of 1.6 g/cm³ or less. This two-layered facing enables the weight to be reduced because its apparent density is 1.6 g/cm³ or less. The apparent density mentioned here is the value obtained by dividing the weight of the facing by the volume of the facing.

A third aspect of the present invention provides a manufacturing method for a backing molding material that is molded integrally with a front material having a friction surface in a two-layered facing, wherein the following steps are provided:

a papermaking step in which a paper sheet is obtained by blending short fibers and pulp material and making them into paper, coating the paper with a binding agent, and drying the same;

a cutting step in which the paper sheet is cut into a tape-like form;

a bending step in which a lengthwise crease is made in the tape-like paper sheet; and

a winding step in which a backing molding material is obtained by winding the creased paper sheet into a ring shape.

With this manufacturing method, the paper sheet is cut into a tape-like form and wound into a ring shape in the winding step to obtain a backing molding material, which is a preparatory material for molding the backing material. This method eliminates the waste of backing material that has occurred conventionally and thus improves the yield of the backing material. Furthermore, since the paper sheet is creased lengthwise after being cut into a tape-like form, the entire facing is squashed according to the crease when the backing molding material and front material are molded together integrally in a subsequent step. It is not entirely necessary to create a crease in the paper sheet if obtaining a high porosity is the only goal. However, by creating a crease as is done in this invention, it becomes possible to manufacture the facing in a more stable manner.

A fourth aspect of the present invention provides the manufacturing method for a backing molding material for a two-layered facing of the third aspect, wherein the papermaking step manufactures the paper sheet such that the basis weight thereof is greater than or equal to 0.025 kg/m² and less than or equal to 0.110 kg/m².

With this paper making step, the paper sheet can be wound satisfactorily in the winding step because the basis weight of the paper sheet is less than or equal to 0.110 kg/m². Meanwhile, since the basis weight is greater than or equal to 0.025 kg/m², it is easy to peel the sheet, which is a fiber substrate containing short fibers and pulp material, from the papermaking screen.

Here, the basis weight is the weight per one square meter of the paper sheet.

A fifth aspect of the present invention provides a manufacturing method for a two-layered facing, having the following steps:

a front material preparation step in which the front material is prepared;

a manufacturing step for a backing molding material as recited in the third or fourth aspect; and

a molding step in which the backing molding material and front material are laminated together and molded to obtain a facing having a two-layered structure.

With this manufacturing method, an inexpensive two-layered facing is obtained because the two-layered facing is manufactured using a backing molding material that has been made at an improved material yield.

A sixth aspect of the present invention provides the manufacturing method for a two-layered facing of the fifth aspect, wherein the molding step is constituted such that molding is conducted while adjusting the degree of compression.

With this manufacturing method, the degree to which the tape-like paper sheet constituting the backing molding material is squashed can be adjusted by adjusting the compression during the molding step. Consequently, the backing material of the two-layered facing can be molded from a state in which air cavities exist in the vicinity of the crease in the backing molding material. Thus, the weight of the facing can be reduced because the apparent density of the facing is small.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic perspective view of a two-layered facing in accordance with a preferred embodiment of the present invention;

FIG. 2 is an elevational view of a backing molding material of the two-layered facing;

FIG. 3 is a cross-sectional view of the backing molding material of the two-layered facing taken along line A-A of FIG. 2;

FIG. 4 is a view of a manufacturing process diagram for the two-layered facing;

FIGS. 5a and 5b are cross-sectional views of illustrating the layered condition of the front material and backing material before a molding step in accordance with a preferred embodiment of the present invention;

FIG. 6 is a cross-sectional view illustrating a layered condition of the front material and backing material after the molding step;

FIGS. 7a and 7b are cross-sectional views of enlarged partial cross sections of FIG. 6;

FIG. 8 is a view of a graph showing the relationship between molding pressure and porosity; and

FIG. 9 is a view of a graph showing the relationship between mold thickness stopper and porosity.

### DETAILED DESCRIPTION OF THE PREFERRED EMBODIMENTS

Selected embodiments of the present invention will now be explained with reference to the drawings. It will be apparent to those skilled in the art from this disclosure that the following description of the embodiments of the present invention is provided for illustration only, and not for the purpose of limiting the invention as defined by the appended claims and their equivalents.

(1) Constituent Features of Two-layered Facing

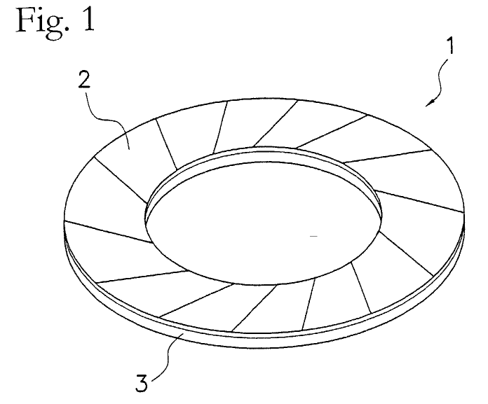

FIG. 1 shows a two-layered facing 1 in accordance with a preferred embodiment of the present invention. The two-layered facing 1 is mounted to an outer circumferential portion of a clutch disc (not shown) and serves to engage frictionally with a flywheel (not shown) by being pressed thereagainst. The two-layered facing 1 is a circular ring-shaped member having a front material 2 and a backing material 3. The front material is pressed directly against the flywheel. The backing material 3 is fixed to a back surface of front material 2 and serves as a strengthening member.

The front material 2 is preferably made of a glass roving substrate impregnated and coated with a friction adjusting agent and a thermosetting resin. Rubbers such as NBR and SBR are preferably used as the rubber of the substrate. Powders of inorganic substances such as calcium carbonate, magnesium carbonate, barium sulfate, and silica and organic substances such as cashew dust and rubber dust are used as the friction adjusting agent. The thermosetting resin is preferably a phenol-based thermosetting resin, e.g., a resol, novolak, or denatured phenol resin. In this particular embodiment, a resol type phenol resin is used.

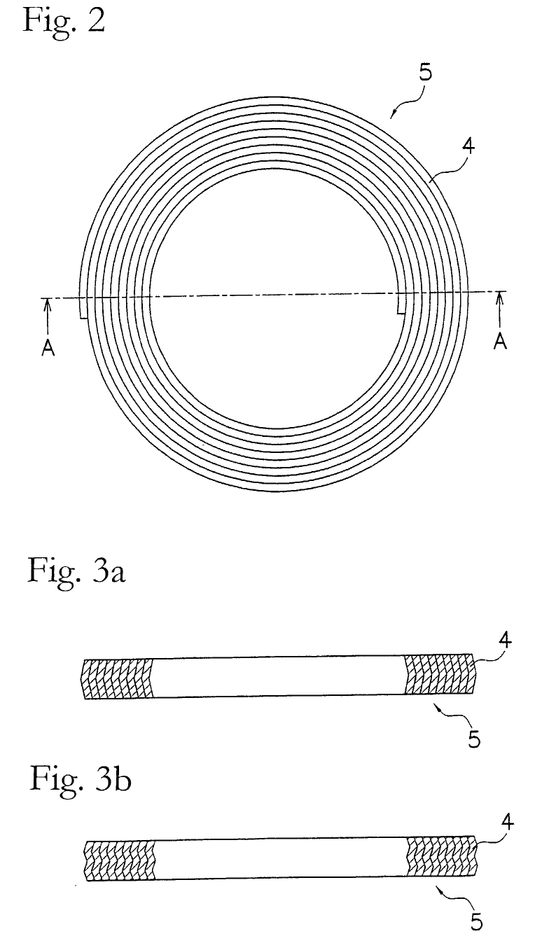

As seen in FIGS. 2 and 3 the backing material 3 is manufactured when a backing molding material 5, which is made of a paper sheet 4 that has been cut into a tape-like form and wound into a ring shape, is molded integrally to the front material 2. The paper sheet 4 is a very thin sheet obtained by blending short fibers and pulp, making the same into a sheet of fiber substrate using a papermaking technique, and coating the sheet with a binding agent. It is not absolutely necessary to include a pulp material; it is also acceptable to use only short fibers.

After being molded integrally with the front material 2, the backing material 3 has many air cavities 6, as shown in the partial cross-sectional view of FIG. 7a. These air cavities 6 are contained in the backing material 3 at a volume percentage of 8% or greater. The air cavities 6 cause the apparent density of the two-layered facing 1 to be 1.6 g/cm³ or less. Also, as described later in more detail, the air cavities 6 are produced by the compression adjusting that takes place when the front material 2 and backing molding material 5 are integrally molded together.

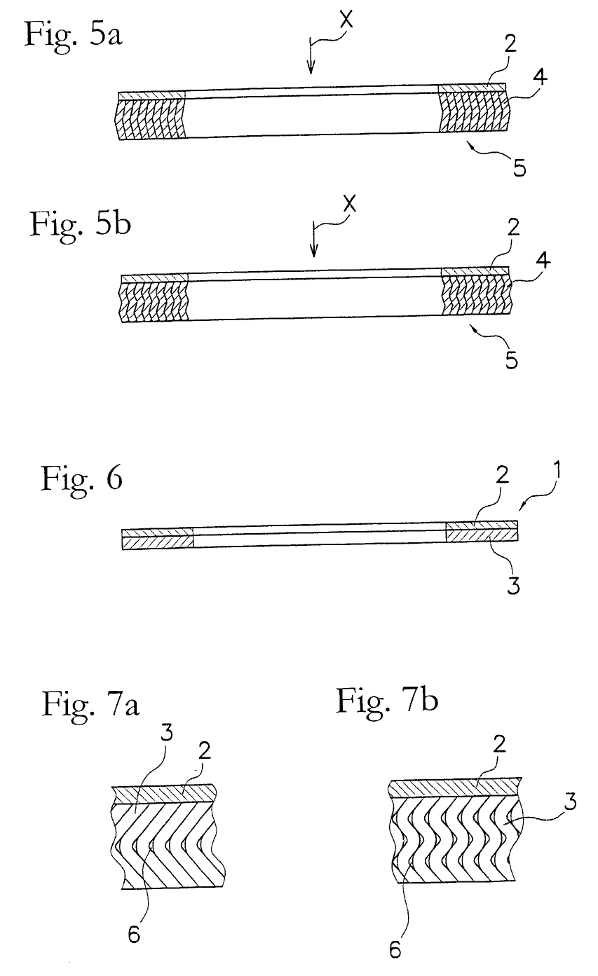

Referring to FIG. 5a, it is preferable that the short fibers contained in the paper sheet 4 be glass fibers or aramid fibers, and the fibers often used have a fiber diameter greater than or equal to 6 μm and less than or equal to 13 μm and a fiber length greater than or equal to 3 mm and less than or equal to 24 mm. The basis weight of paper sheet 4 is greater than or equal to 0.025 kg/m² and less than or equal to 0.110 kg/m².

The pulp contained in the paper sheet 4 has natural fibers, synthetic fibers, or a blend of a plurality of these. Examples of natural fibers used include wood fibers and leaf fibers and examples of synthetic fibers include aramid and polyester. The binding agent contained in the paper sheet 4 is a phenol-based thermosetting resin, e.g., a resol, novolak, or denatured phenol resin.

Because the backing material 3 contains multiple air cavities 6, the two-layered facing 1 described here has a small apparent density and is light in weight.

(2) Manufacturing Method for Two-layered Facing

Next, the method of manufacturing the two-layered facing 1 is described.

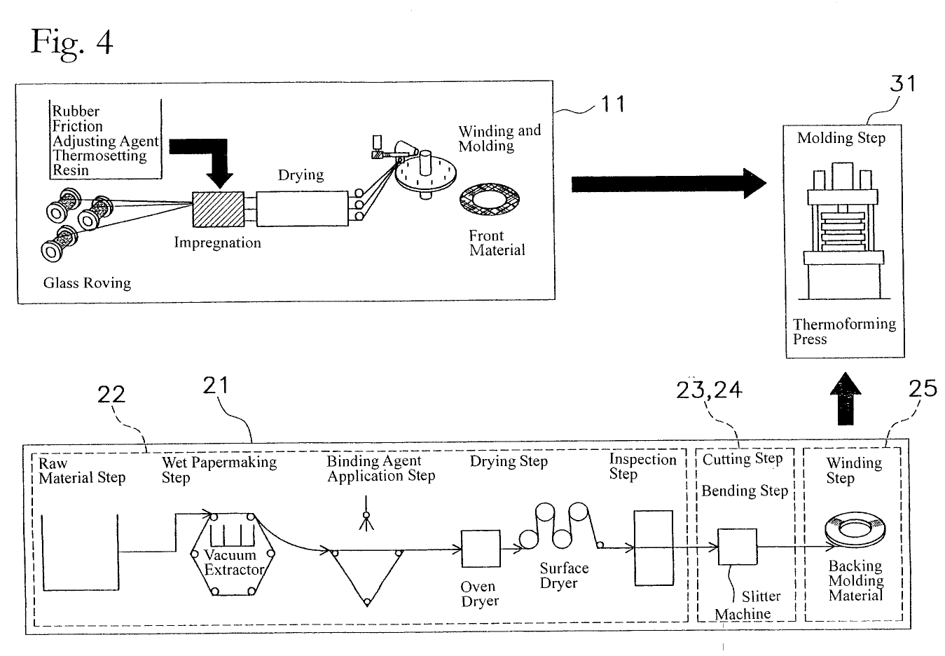

FIG. 4 shows a manufacturing process for the two-layered facing 1 in accordance with a preferred embodiment of the present invention. This manufacturing process has the following steps: a front material preparation step 11 in which the front material 2 is prepared; a backing material preparation step 21 in which the backing molding material 5 is prepared; and a molding step 31 in which the two materials are laminated together and molded to obtain the two-layered facing 1.

First, in the front material preparation step 11, a glass roving substrate impregnated and coated with a friction adjusting agent and a thermosetting resin is dried and rolled to manufacture the front material 2.

Separately from the preparation of the front material 2, the backing molding material 5 is manufactured in the backing preparation step 21. The backing material preparation step 21 has the following steps:

a papermaking step 22 in which short fibers and pulp material are blended and made into a paper which is then coated with a binding agent and dried to obtain the paper sheet 4;

a cutting step 23 in which the paper sheet 4 is cut into a tape-like form;

a bending step 24 in which a lengthwise crease is made in the tape-like paper sheet 4; and

a winding step 25 in which the creased paper sheet 4 is wound into a ring shape to obtain the backing molding material 5.

In the papermaking step 22, the paper sheet 4 is made according to the following steps using short fibers and pulp as raw materials.

\mathring{1} Raw Material Step

Short fibers and pulp are dispersed in water and blended to make a slurry. The slurry is adjusted to a concentration appropriate for wet papermaking and sent to a wet papermaking step.

\mathring{2} Wet Papermaking Step

The concentration-adjusted slurry is directed to a papermaking machine and a sheet of fiber substrate containing short fibers and pulp is made on a papermaking screen provided in the papermaking machine. The sheet is then dewatered in a vacuum extractor, peeled off the screen, and sent to the coating step.

\mathring{3} Binding Agent Deposition Step

A binding agent made of powdered thermosetting resin is sprayed onto the dewatered fiber substrate sheet, which contains short fibers and pulp. It is also acceptable to apply a liquefied thermosetting resin binding agent such that it impregnates the substrate sheet.

\mathring{4} Drying Step

After the binding agent is applied to the fiber substrate sheet, which contains short fibers and pulp, the sheet is rough dried in an oven dryer. Then the sheet is dried further with a surface dryer and the paper sheet 4 is obtained.

\mathring{5} Inspection Step

Before the dried paper sheet 4 is sent to the winding step 25, it is inspected for defects and the proper basis weight. More specifically, the basis weight is inspected to make sure it is greater than or equal to 0.025 kg/m² and less than or equal to 0.110 kg/m². If the inspection finds that the basis weight is outside the range defined by the aforementioned values, the concentration of the slurry used in the raw material step is readjusted.

In the cutting step 23, the paper sheet 4 obtained from the papermaking step 22 is cut into a tape-like form with a slitter machine. The width of the resulting tape is such that a prescribed thickness is obtained for the backing material 3 when the tape is squashed in the molding step 31 (discussed later).

In the bending step 24, a lengthwise crease is made in the tape-like paper sheet 4. The crease is made such that after the paper sheet is wound in the winding step 25 (discussed later), the backing molding material 5 has a V-shaped or W-shaped radial cross direction, as shown in FIG. 3a and FIG. 3b.

Referring again to FIG. 4, in the winding step 25, the creased tape-like paper sheet 4 is wound to the prescribed diameter of the backing material 3 and becomes the backing molding material 5. In short, the thickness of the backing material 3 is adjusted by the width of the tape-like paper sheet 4 obtained in the cutting step 23 and the diameter of the backing material 3 is adjusted by the number of windings of the tape-like paper sheet 4.

In the molding step 31, as shown in FIGS. 5a and 5b, the front material 2 manufactured in the front material preparation step 11 and the backing molding material 5 manufactured in the backing material preparation step 21 are laminated together and molded integrally by applying pressure in the direction of arrow X using a thermoforming press. As result, the two-layered facing 1 shown in FIG. 6 is obtained. When the integral molding is conducted, the backing molding material 5 is squashed, for example, in accordance with the V-shaped crease and in the direction of arrow X shown in FIG. 5a until it reaches the prescribed thickness of the backing material 3.

In order to avoid squashing the V-shaped crease shown in FIG. 5a completely, the pressing pressure of the thermoforming press is reduced during the thermoforming or a thickness stopper is inserted into the mold of the thermoforming press before thermoforming is conducted. Thus, as shown in FIG. 7a, the multitude of air cavities 6 are formed in the vicinity of where the creases were before molding was conducted. If the backing molding material 5 has a W-shaped crease, as shown in FIG. 5b, the multiple air cavities 6 shown in FIG. 7b can be formed in the same manner.

The two-layered facing manufacturing method described here achieves a better yield from the material used to make the backing material 3 than conventional methods because the backing molding material 5, which is the preparatory material that is molded to make the backing material 3, is manufactured in the backing material preparation step 21 that is provided with the winding step 23. Thus, the relatively inexpensive two-layered facing 1 is obtained because the two-layered facing 1 is manufactured using the backing molding material 5 whose material yield has been improved. Also, since the bending step 24 makes a lengthwise crease in the tape-like paper sheet 4, the facing is squashed according to the crease during the molding step 31, making it possible to achieve stable manufacturing.

Additionally, by adjusting the compression, one can adjust the degree to which the tape-like paper sheet 4 that constitutes the backing molding material 5 is squashed during molding and the backing material 3 of the two-layered facing 1 can be molded from a state in which the air cavities 6 exist in the vicinity of the crease in the backing molding material 5. Thus, the weight of backing material 3 can be reduced, because the apparent density of the facing is small. Also, since the porosity of the backing material 3 is high, the heat radiation performance is improved and, thus, the fade resistance and stall resistance are improved.

(3) Working Example

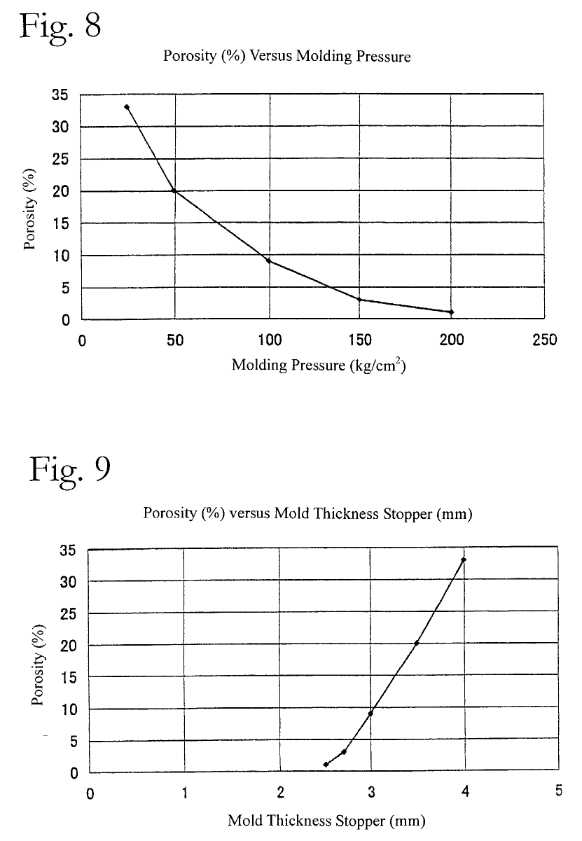

FIG. 8 and FIG. 9 show how the porosity of the backing material 3 of two-layered facing 1 varies in a case in which the pressure is adjusted during press forming and a case in which a thickness stopper is inserted into the mold of the thermoforming press, respectively.

As shown in FIG. 8, the porosity falls below 5% when the molding pressure is 150 to 200 kg/cm², but high porosity, i.e., 8% or higher, is obtained when the molding step is conducted with a molding pressure of 100 kg/cm² or less.

Similarly, although almost zero air cavities will be formed if molding is conducted at a molding pressure of 200 kg/cm² without inserting a thickness stopper into the mold of the thermoforming press, the facing can be manufactured so as to have a stable porosity and apparent density by adjusting the mold thickness stopper such that the desired porosity is obtained and ending the compression at a molding pressure of 200 kg/cm².

More specifically, as shown in FIG. 9, a high porosity of 8% or greater can be obtained by inserting a mold thickness stopper of 3 mm or greater.

Since the backing molding material 5 has circumferential creases as shown in the radial cross section of FIG. 5, the facing is squashed according to the creases during molding. As a result, stable manufacturing is achieved while maintaining a high porosity.

### EFFECTS OF THE INVENTION

The two-layered facing of the present invention does not waste the material used to make the backing material in the manner conventional two-layered facings do because the backing molding material, which is a preparatory material molded to make the backing material, is obtained by cutting a paper sheet into a tape-like form and winding it into a ring shape. Consequently, the yield of the material used to make the backing material is improved and an inexpensive two-layered facing is obtained. Furthermore, by adjusting the compression during the integral molding step, the porosity of the backing material can be increased and the heat resistance can be improved. In short, the present invention makes it possible to improve such performance factors as lightness in weight and heat resistance while maintaining the rotational strength of the facing by using a two-layered structure comprising a front material and a backing material.

As used herein, the following directional terms “forward, rearward, above, downward, vertical, horizontal, below, and transverse” as well as any other similar directional terms refer to those directions of a device equipped with the present invention. Accordingly, these terms, as utilized to describe the present invention should be interpreted relative to a device equipped with the present invention.

The terms of degree such as “substantially,” “about,” and “approximately” as used herein mean a reasonable amount of deviation of the modified term such that the end result is not significantly changed. These terms should be construed as including a deviation of at least ±5% of the modified term if this deviation would not negate the meaning of the word it modifies.

This application claims priority to Japanese Patent Application No. 2001-387755 and Japanese Patent Application No. 2002-264251. The entire disclosures of Japanese Patent Application No. 2001-387755 and Japanese Patent Application No. 2002-264251 are hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A two-layered facing comprising:
a front material having a friction surface; and
a backing material comprising a backing molding material being obtained by winding a paper sheet containing short fibers, pulp material, and a binding agent into a ring shape, said backing molding material being molded integrally with said front material, said backing material having a porosity of 8% or more by volume.

2. The two-layered facing according to claim 1, wherein the apparent density is 1.6 g/cm³ or less.

3. The two-layered facing according to claim 2, wherein said paper sheet has a basis weight greater than or equal to 0.025 kg/m² and less than or equal to 0.110 kg/m².

4. The two-layered facing according to claim 3, wherein said front material comprises a glass roving substrate impregnated and coated with a friction adjusting agent and a thermosetting resin.

5. The two-layered facing according to claim 4, wherein said glass roving substrate contains a rubber.

6. The two-layered facing according to claim 5, wherein said rubber is selected from the group consisting of NBR and SBR.

7. The two-layered facing according to claim 4, wherein said friction adjusting agent comprises organic and/or inorganic substances.

8. The two-layered facing according to claim 7, wherein said inorganic substances are selected from the group consisting of calcium carbonate, magnesium carbonate, barium sulfate, and silica.

9. The two-layered facing according to claim 7, wherein said organic substances are selected from the group consisting of cashew dust and rubber dust.

10. The two-layered facing according to claim 1, wherein said short fibers have a fiber diameter greater than or equal to 6 μm and less than or equal to 13 μm, and a fiber length greater than or equal to 3 mm and less than or equal to 24 mm.

11. The two-layered facing according to claim 1, wherein said short fibers are selected from the group consisting of glass fibers or aramid fibers.

12. The two-layered facing according to claim 1, wherein said paper sheet has a basis weight greater than or equal to 0.025 kg/m² and less than or equal to 0.110 kg/m².

13. The two-layered facing according to claim 12, wherein said front material comprises a glass roving substrate impregnated and coated with a friction adjusting agent and a thermosetting resin.

14. The two-layered facing according to claim 13, wherein said friction adjusting agent comprises organic and/or inorganic substances.

15. A manufacturing method for a backing molding material comprising:
obtaining a paper sheet by blending short fibers and pulp material and making said short fibers and pulp material into paper, coating said paper with a binding agent, and drying said paper to produce said paper sheet;
cutting said paper sheet into a tape form;
creasing said tape form paper sheet lengthwise; and
winding said creased paper sheet into a ring shape to obtain said backing molding material.

16. The manufacturing method for a backing molding material according to claim 15, wherein said paper sheet obtained by blending short fibers and pulp material and making said short fibers and pulp material into paper, coating said paper with a binding agent, and drying said paper to produce said paper sheet has a basis weight greater than or equal to 0.025 kg/m² and less than or equal to 0.110 kg/m².

17. A manufacturing method for a two-layered facing, comprising:
preparing a front material;
obtaining a paper sheet by blending short fibers and pulp material and making said short fibers and pulp material into paper, coating said paper with a binding agent, and drying said paper to produce said paper sheet;
cutting said paper sheet into a tape form;
creasing said tape form paper sheet lengthwise;
winding said creased paper sheet into a ring shape to obtain a backing molding material;
molding said backing molding material and said front material to laminate said backing molding material and said front material together to obtain a facing having a two-layered structure.

18. The manufacturing method for a two-layered facing according to claim 17, wherein molding said backing molding material and said front material to laminate said backing molding material and said front material together to obtain a facing having a two-layered structure is conducted while adjusting degree of compression.

19. The manufacturing method for a two-layered facing according to claim 18, wherein a backing material having a porosity of at least 8% results from molding said backing molding material and said front material.

20. The manufacturing method for a two-layered facing according to claim 19, wherein said two-layered structure has an apparent density of 1.6 g/cm³ or less.

21. The manufacturing method for a two-layered facing according to claim 17, wherein said short fibers have a fiber diameter greater than or equal to 6 μm and less than or equal to 13 μm, and a fiber length greater than 3 mm and less than or equal to 24 mm.

22. The manufacturing method for a two-layered facing according to claim 21, wherein said short fibers are selected from the group consisting of glass fibers or aramid fibers.

23. The manufacturing method for a two-layered facing according to claim 17, wherein said paper sheet has a basis weight greater than or equal to 0.025 kg/m² and less than or equal to 0.110 kg/m².

24. The manufacturing method for a two-layered facing according to claim 17, wherein preparing said front material comprises,
impregnating and coating a glass roving substrate with a friction adjusting agent and thermosetting resin, and
drying and rolling said glass roving substrate.

25. The manufacturing method for a two-layered facing according to claim 17, wherein obtaining said paper sheet further comprises,
dispersing and blending said short fibers and said pulp material in an aqueous solution to make a slurry,
arranging said slurry on a papermaking screen to produce a substrate sheet,
dewatering said substrate sheet,
coating said substrate sheet with said binding agent comprising a powdered thermosetting resin binding agent, and
drying said substrate sheet to produce said paper sheet.

26. The manufacturing method for a two-layered facing according to claim 25, wherein obtaining said paper sheet further comprises,
inspecting said paper sheet to ensure that said paper sheet has a basis weight greater than or equal to 0.025 kg/m² and less than or equal to 0.110 kg/m², and
adjusting a concentration of said slurry if said basis weight is outside of the range.

27. The manufacturing method for a two-layered facing according to claim 17, wherein creasing said tape form paper sheet provides said backing molding material with a V-shaped or W-shaped radial cross direction.
